(19) United States
(12) Patent Application Publication
(10) Pub. No.: US 2015/0055565 A1
(43) Pub. Date: Feb. 26, 2015

(54) RADIO RESOURCE CONTROL DORMANCY TIMER BASED ON TRAFFIC TYPE

(71) Applicant: Verizon Patent and Licensing Inc., Arlington, VA (US)

(72) Inventors: Lalit R. Kotecha, San Ramon, CA (US); Sagiv Draznin, Walnut Creek, CA (US)

(73) Assignee: VERIZON PATENT AND LICENSING INC., Arlington, VA (US)

(21) Appl. No.: 13/973,210

(22) Filed: Aug. 22, 2013

(51) Int. Cl. H04W 76/06; H04W 24/02

(52) U.S. Cl. CPC H04W 76/068; H04W 24/02
USPC 370/329

(57) ABSTRACT

A device may be configured to determine a type of traffic, received by the device from a user device; identify a radio resource control (“RRC”) timeout value associated with the type; start an RRC dormancy timer based on the RRC timeout value; and modify, based on expiration of the RRC dormancy timer, an RRC channel between the device and the user device.

### BACKGROUND

Wireless telecommunications networks allow user devices, such as cellular telephones, to communicate with other devices or networks. Base stations in wireless networks may include wireless transceivers with which user devices may communicate. A base station may establish a Radio Resource Control (“RRC”) channel for each user device, via which the base station and the user device may perform control signaling. RRC channels may be associated with modes (e.g., one or more active modes or an idle mode), which may consume different levels of power or other resources. For each RRC channel, the base station may maintain a dormancy timer (also referred to as an inactivity timer), based on which the base station may change the mode of the RRC channel (e.g., switch from an active mode to an idle mode).

### BRIEF DESCRIPTION OF THE DRAWINGS

FIG. 1 illustrates an example situation in which a global RRC timeout value may be problematic;

FIGS. 2A and 2B illustrate an example overview of one or more implementations described herein;

FIG. 3 illustrates an example environment in which systems and/or methods, described herein, may be implemented;

FIG. 4 illustrates an example data structure that may be stored by a base station in accordance with some implementations;

FIG. 5 illustrates an example process for maintaining RRC dormancy timers that are based on types of received traffic;

FIG. 6 illustrates an example use case of an RRC dormancy timer, in accordance with some implementations; and

FIG. 7 illustrates example components of one or more devices, according to one or more implementations described herein.

### DETAILED DESCRIPTION OF PREFERRED EMBODIMENTS

The following detailed description refers to the accompanying drawings. The same reference numbers in different drawings may identify the same or similar elements.

Base stations of wireless networks may use radio resource control (“RRC”) channels for control signaling between the base stations and user devices, such as wireless telephones. RRC channels may be associated with different modes, such as an idle mode and/or one or more active modes. A base station may maintain an RRC channel per user device (e.g., up to one RRC channel per user device, in some implementations), and may maintain a timer for each RRC channel. The timer may be used in order to change the mode of the RRC channel. Changing the mode of the RRC channel to an idle state, or a less active state, may save resources when the RRC channel is not being used. For instance, upon expiration of an RRC timeout value (e.g., no traffic has been sent to or received from a particular user device for a particular length of time associated with the RRC timeout value), a base station may “tear down” an RRC channel, or set the mode of the RRC channel to “idle.”

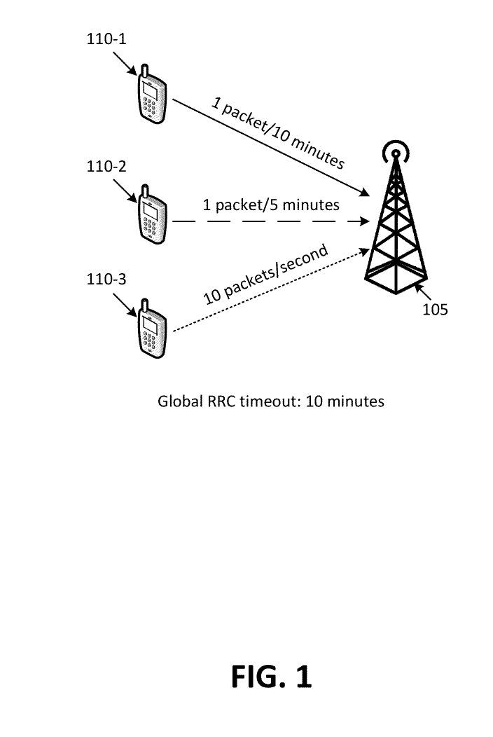

FIG. 1 illustrates an example situation in which a base station uses a global RRC timeout value. As shown, base station 105 may be in communication with three user devices 110-1, 110-2, and 110-3 (hereinafter sometimes referred to collectively as “user devices 110,” or individually as “user device 110”). As shown, user device 110-1 may transmit a data packet to base station 105 approximately once every ten minutes, user device 110-2 may transmit a data packet to base station 105 approximately once every five minutes, and user device 110-3 may transmit a data packet to base station 105 approximately ten times per second. As further indicated in the figure, base station 105 may maintain a global RRC timeout value of ten minutes. That is, when traffic has not been received from or sent to a particular user device 110 for ten minutes, base station 105 may “tear down” the RRC channel associated with the particular user device 110.

In some situations, particular values for an RRC timeout may be desirable for some types of traffic, but less desirable for other types of traffic. For example, as shown in FIG. 1, an RRC channel may be continuously maintained between user device 110-1 and base station 105, even though user device 110-1 only sends one packet every ten minutes. In this situation, nearly the entire uptime of this RRC channel may be unused, causing the unnecessary consumption of resources, such as power resources, processor resources, and/or network resources.

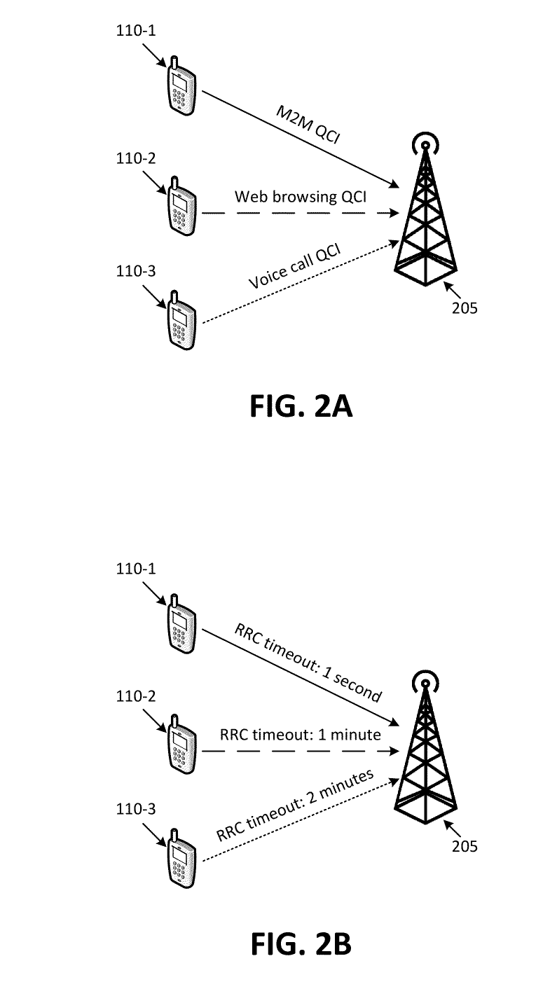

Techniques described herein may maintain RRC idle timers that may be set based on types of traffic being sent to or from user devices. FIGS. 2A and 2B illustrate a simplified example of one or more implementations, in which base station 210 may maintain different RRC idle timers for different user devices 110, based on the types of traffic associated with respected user devices 110. For example, as shown in FIG. 2A, base station 205 may identify that traffic, associated with user device 110-1, generally consists of mobile to mobile (“M2M”) protocol messages. For instance, base station 205 may identify that the traffic, sent to or received from user device 110-1, is associated with a quality of service (“QoS”) class indicator (“QCI”) that corresponds to M2M traffic. As also shown in FIG. 2A, base station 210 may identify that traffic, received from and/or sent to user device 110-2, is associated with a web browsing QCI, and that traffic, received from and/or sent to user device 110-3, is associated with a voice call QCI.

Based on the different QCIs associated with the traffic received from different user devices 110, base station 205 may maintain RRC timeout timers with different RRC timeout values for each user device 110. For example, as shown in FIG. 2B, the RRC timeout value for user device 110-1 may be one second, the RRC timeout value for user device 110-2 may be one minute, and the RRC timeout value for user device 110-3 may be two minutes. Maintaining different RRC timeout values for different QCIs may allow an administrator of base station 210 to more finely control the resource usage of base station 210, in a manner that conserves resources without significantly adversely affecting network performance.

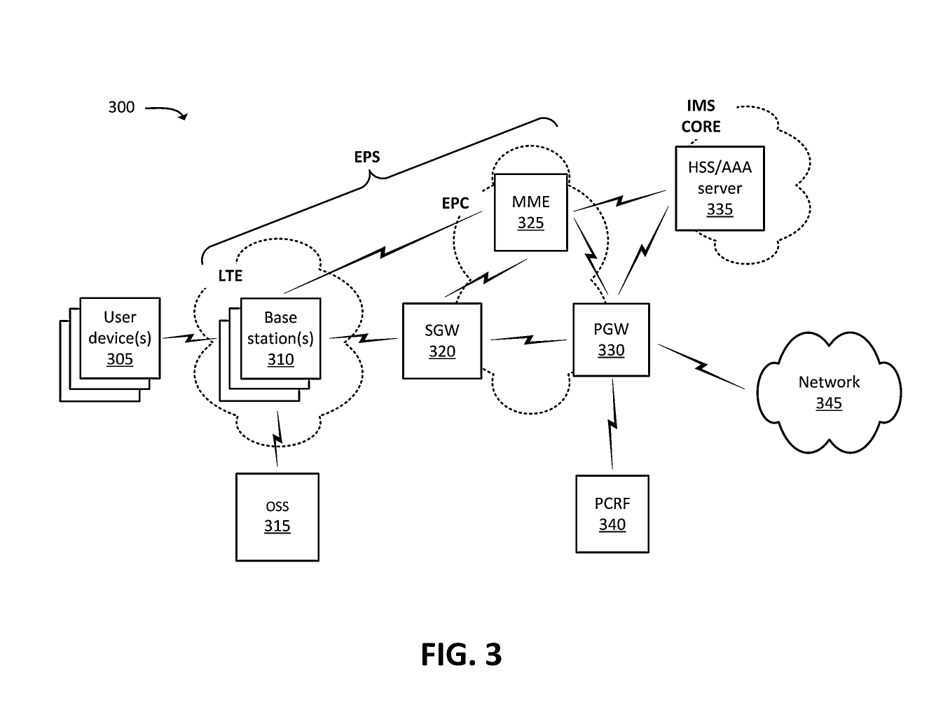

FIG. 3 illustrates an example environment 300, in which systems and/or methods described herein may be implemented. As shown in FIG. 3, environment 300 may include one or more user devices 305 (referred to collectively as “user devices 305,” or individually as “user device 305”), one or more base stations 310 (referred to collectively as “base stations 310,” or individually as “base station 310”), operations support system (“OSS”) 315, serving gateway (“SGW”) 320, mobility management entity device (“MME”) 325, packet data network (“PDN”) gateway (“PGW”) 330, home subscriber server (“HSS”)/authentication, authorization, accounting (“AAA”) server 335 (hereinafter referred to as “HSS/AAA server 335”), policy charging and rules function (“PCRF”) 340, and network 345.

The quantity of devices and/or networks, illustrated in FIG. 3, is provided for explanatory purposes only. In practice, there may be additional devices and/or networks; fewer devices and/or networks; different devices and/or networks; or differently arranged devices and/or networks than illustrated in FIG. 3. Alternatively, or additionally, one or more of the devices of environment 300 may perform one or more functions described as being performed by another one or more of the devices of environment 300. Devices of environment 300 may interconnect via wired connections, wireless connections, or a combination of wired and wireless connections.

Environment 300 may include an evolved packet system (“EPS”) that includes a long term evolution (“LTE”) network and/or an evolved packet core (“EPC”) network that operate based on a third generation partnership project (“3GPP”) wireless communication standard. The LTE network may be, or may include, a radio access network (“RAN”) that includes one or more base stations 310, some or all of which may take the form of an eNodeB (“eNB”), via which user device 305 may communicate with the EPC network. The EPC network may include one or more SGWs 320, MMEs 325, and/or PGWs 330, and may enable user device 305 to communicate with network 345 and/or an Internet protocol (“IP”) multimedia subsystem (“IMS”) core network. The IMS core network may include HSS/AAA server 335, and may manage authentication, session initiation, account information, a user profile, etc. associated with user device 305.

User device 305 may include any computation and communication device, such as a wireless mobile communication device that is capable of communicating with one or more networks (e.g., network 345 and/or the IMS core). For example, user device 305 may include a radiotelephone; a personal communications system (“PCS”) terminal (e.g., a device that combines a cellular radiotelephone with data processing and data communications capabilities); a personal digital assistant (“PDA”) (e.g., that can include a radiotelephone, a pager, Internet/intranet access, etc.); a smart phone; a laptop computer; a tablet computer; a camera; a personal gaming system, or another type of mobile computation and communication device. User device 305 may send traffic to and/or receive traffic from network 345 via signal bearers, such as base station 310, SGW 320, and/or PGW 330.

Base station 310 may include one or more network devices that receive, process, and/or transmit traffic, such as calls, audio, video, text, and/or other data, destined for and/or received from user device 305. In one example, base station 310 may be an eNB device and may be part of the LTE network. Base station 310 may receive traffic from and/or send traffic to network 345 via SGW 320 and PGW 330. Base station 310 may send traffic to and/or receive traffic from user device 305 via an air interface.

In some implementations, base station 310 may establish RRC channels with user devices 305 (e.g., up to one RRC channel per user device 305), in order to perform control signaling, such as session establishment and release, broadcast of system information, radio bearer establishment or reconfiguration, paging notification and release, and/or other signaling. In some implementations, the RRC channel may be based on an RRC standard developed by the 3GPP. RRC channels may be associated with one or more modes. For example, an RRC channel may be associated with an “idle” mode or a particular one of a set of “connected” modes, such as a “dedicated channel” mode, a “forward access channel” mode, a “cell paging channel” mode, or a “Universal Terrestrial Radio Access Network (‘UTRAN’) Registration Area (‘URA’) Paging channel” mode. The different RRC modes may provide different functionalities, and may consume different amounts of resources. Examples of these functionalities are described in the document, “Technical Specification Group Radio Access Network; Radio Resource Control (RRC); Protocol Specification (Release 11),” 3GPP TS 25.331 v11.6.0, June 2013.

As described further below, in some implementations, base station 310 may maintain one or more dormancy timers (e.g., one dormancy timer per RRC channel), based on which base station 310 may change the mode of an RRC channel. Base station 310 may, for example, set a timeout value, associated with a particular dormancy timer, based on a type of traffic sent or received by a user device 305 associated with a corresponding RRC channel.

OSS 315 may include one or more server devices, or other types of devices, that support processes such as maintaining network inventory, provisioning services, configuring network components, and managing faults. In some implementations, OSS 315 may receive configuration information for RRC dormancy timers from one or more users (such as, for example, an administrator associated with OSS 315). This configuration information may include, for example, information correlating different types of traffic (e.g., traffic having different QCIs) with different RRC timeout values. In some such implementations, OSS 315 may provide some or all of this information regarding RRC dormancy timer configurations, and/or other information, to base station 310. In some implementations, the functionality performed by OSS 315 may be implemented by other devices or network elements, such as by MME 325.

SGW 320 may include one or more network devices that gather, process, search, store, and/or provide information. For example, SGW 320 may include a gateway, a router, a modem, a switch, a firewall, a network interface card (“NIC”), a hub, a bridge, a proxy server, and/or some other type of device that processes and/or transfers traffic. SGW 320 may, for example, aggregate traffic received from one or more base stations 310 and may send the aggregated traffic to network 345 via PGW 330.

MME 325 may include one or more computation and communication devices that gather, process, search, store, and/or provide information. For example, MME 325 may perform operations to register user device 305 with the EPS, to establish bearer channels associated with a session with user device 305, to hand off user device 305 from the EPS to another network, to hand off user device 305 from the other network to the EPS, and/or to perform other operations. MME 325 may perform policing operations on traffic destined for and/or received from user device 305.

PGW 330 may include one or more network devices, or other types of computation and communication devices, that gather, process, search, store, and/or provide information in a manner described herein. For example, PGW 330 may include a gateway, a router, a modem, a switch, a firewall, a network interface card (“NIC”), a hub, a bridge, a proxy server, an optical add-drop multiplexer (“OADM”), and/or some other type of device that processes and/or transfers traffic. PGW 330 may aggregate traffic received from one or more SGWs 320, and may send the aggregated traffic to network 345. PGW 330 may also, or alternatively, receive traffic from network 345 and may send the traffic toward user device 305 via SGW 320, and/or base station 310.

HSS/AAA server 335 may include one or more server devices, or other types of devices, that gather, process, search, store, and/or provide information. For example, HSS/AAA server 335 may manage, update, and/or store, in a memory associated with HSS/AAA server 335, profile information associated with a subscriber. The profile information may identify applications and/or services that are permitted for and/or accessible by the subscriber; a mobile directory number (“MDN”) associated with the subscriber; bandwidth or data rate thresholds associated with the applications and/or services; information associated with the subscriber (e.g., a username, a password, etc.); rate information; minutes allowed for a subscriber; and/or other information. The subscriber may be associated with user device 305 and/or one or more other user devices 305. Additionally, or alternatively, HSS/AAA server 335 may perform authentication, authorization, and/or accounting operations associated with the subscriber and/or a communication session with user device 305.

PCRF 340 may include one or more server devices, or other types of devices, that aggregate information to and from the EPC network and/or other sources. PCRF 340 may receive information regarding policies and/or subscriptions from one or more sources, such as subscriber databases and/or from one or more users (such as, for example, an administrator associated with PCRF 340).

Network 345 may include one or more wired and/or wireless networks. For example, network 345 may include a cellular network, a public land mobile network (“PLMN”), a second generation (“2G”) network, a third generation (“3G”) network, a fourth generation (“4G”) network, a fifth generation (“5G”) network, and/or another network. Additionally, or alternatively, network 345 may include a wide area network (“WAN”), a metropolitan area network (“MAN”), a telephone network (e.g., the Public Switched Telephone Network (“PSTN”)), an ad hoc network, an intranet, PDN (e.g., the Internet), a fiber optic-based network, and/or a combination of these or other types of networks.

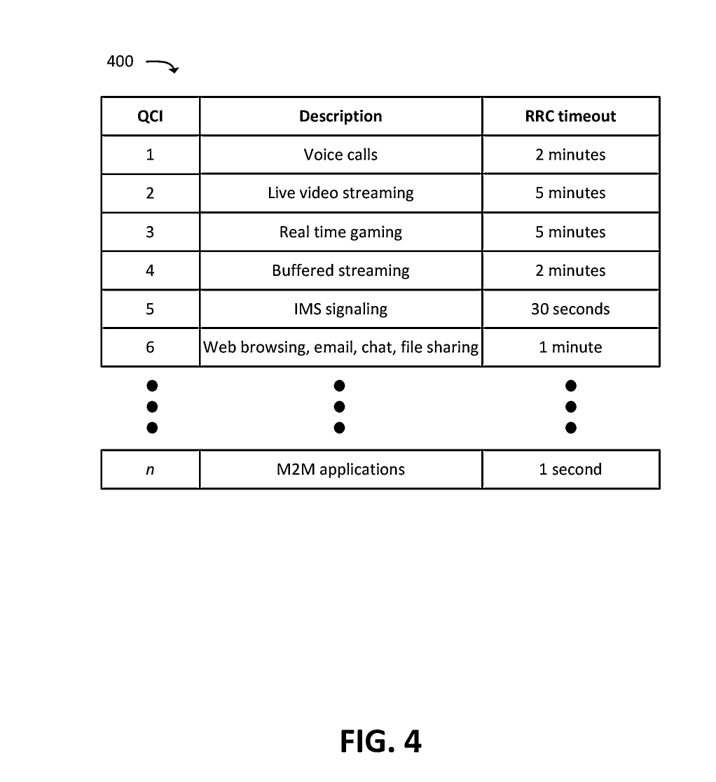

FIG. 4 illustrates an example data structure 400 that may be stored by base station 310 and/or another device. Data structure 400 may store information that correlates types of traffic to RRC timeout values. For example, data structure may include a QCI field, a description field, and an RRC timeout field. The QCI field may indicate a QCI level associated with traffic. The QCI level may be one particular level, out of a predefined set of QCI levels. In some implementations, the set of QCI levels may range from one to nine. In other implementations, the set of QCI levels may include a different range. The description field may include a textual description of types of traffic. For instance, the description field may indicate that voice calls are associated with QCI level 1, live video streaming is associated with QCI level 2, etc. The RRC timeout value may indicate a duration of time, which may be used in operating an RRC dormancy timer associated with a particular type of traffic. For instance, QCI level 1 traffic may be associated with a two-minute RRC timeout value, QCI level 2 traffic may be associated with a five-minute RRC timeout value, etc.

The information stored in data structure 400 may be received from OSS 315 and/or another device. For example, an administrator may manually enter some or all of the information stored in data structure 400. In some implementations, some or all of the information stored in data structure 400 may be automatically generated or modified.

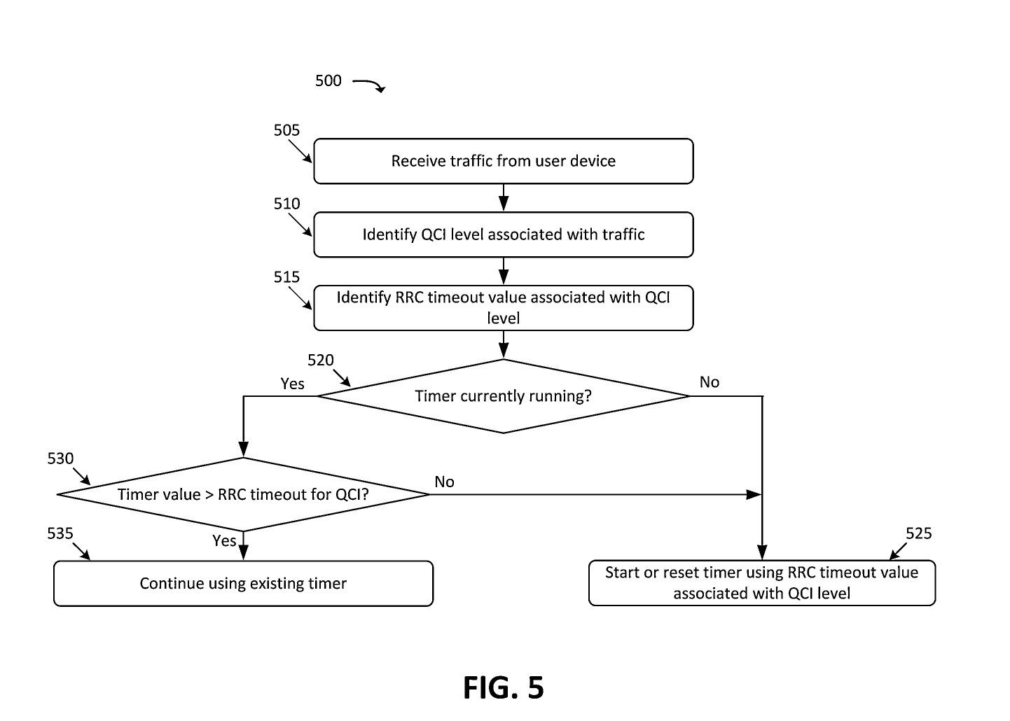

FIG. 5 illustrates an example process for maintaining RRC dormancy timers that are based on types of received traffic. In one example implementation, process 500 may be performed by base station 310. In some implementations, some or all of process 500 may be performed by one or more other devices in lieu of, or in conjunction with, base station 310. For example, base station 310 may be communicatively coupled to one or more other devices that perform some or all of process 500.

Process 500 may include receiving traffic associated with a user device (block 505). For example, base station 310 may receive traffic from a particular user device 305, or directed to the particular user device 305 (e.g., traffic received from network 345).

Process 500 may also include identifying a QCI level associated with the received traffic (block 510). For example, the traffic may include header information and/or other indicators, based on which base station 310 may identify a QCI level associated with the traffic.

Process 500 may further include identifying an RRC timeout value associated with the identified QCI level (block 515). For example, base station 310 may compare the identified QCI level to information stored in data structure 400, in order to determine the RRC timeout value that corresponds to the QCI level.

Process 500 may additionally include determining whether an RRC dormancy timer, associated with the user device, is currently running (block 520). As described above, an RRC channel may be active (e.g., in a “connected” mode) between base station 310 and the particular user device 305. When an RRC channel is active, base station 310 may maintain an RRC dormancy timer, based on which base station 310 may modify the mode of the RRC channel.

If an RRC dormancy timer is not currently running (block 520—NO), then process 500 may include starting an RRC dormancy timer using the RRC timeout value associated with the QCI level (block 525). For example, assume that base station 310 determines (at block 510) that the traffic (received at block 505) is associated with QCI level 1, and thusly determines (at block 515) that the RRC timeout value is one minute. Base station 310 may start an RRC dormancy timer, associated with user device 305 (from which the traffic was received), and may set the RRC dormancy timer at one minute. Furthermore, base station 310 may change the mode of an RRC channel between user device 305 and base station 310 (e.g., may change the mode from an idle mode to a particular active mode, out of a set of active modes), or may establish a new RRC channel if an RRC channel does not currently exist for user device 305.

If traffic, associated with user device 305, is subsequently received by base station 310, then base station 310 may reset the RRC dormancy timer. For example, as described below with respect to block 525, base station 310 may reset the RRC dormancy timer based on the QCI level of the subsequently received traffic.

If traffic, associated with user device 305, is not received by base station 310 before expiration of the RRC dormancy timer, base station 310 may modify the mode of the RRC channel associated with user device 305. For example, base station 310 may switch the mode of the RRC channel from an active mode to the idle mode, or may switch the mode of the RRC channel from one active mode to another active mode (e.g., another active mode that consumes fewer resources). In some implementations, upon expiration of the RRC dormancy timer, base station 310 may “tear down” the RRC dormancy timer (e.g., de-allocate processor and/or memory resources that were allocated for the RRC dormancy timer).

If an RRC dormancy timer is currently running (block 520—YES), then process 500 may include determining whether a current value (e.g., a value of the timer as the timer is running) of the RRC dormancy timer is greater than the RRC timeout value associated with the QCI level of the traffic (block 530). If the current value of the RRC dormancy timer is greater than the RRC timeout value associated with the QCI level of the traffic (block 520—YES and block 530—YES), then process 500 may include continuing to use the existing timer (block 535). Such a situation may occur when different types of traffic, associated with the same user device 305, are received by base station 310.

For instance, referring to the example information shown in FIG. 4, assume that base station 310 receives gaming traffic (QCI level 3) from user device 305. In this situation, base station 310 may have started (at block 525, during a previous iteration of process 500) an RRC dormancy timer with an RRC timeout value of five minutes. Assume that, one minute later, base station 310 receives voice call traffic (QCI level 1) from user device 305. Since four minutes would be left on the existing RRC dormancy timer (i.e., longer than the one minute RRC timeout value associated with QCI level 1), base station 310 may continue using the existing RRC dormancy timer. In this sense, base station 310 may avoid inappropriately “cutting short” RRC dormancy timers when multiple different traffic types are received for a particular user device 305.

If, on the other hand, the current value of an existing RRC dormancy timer is not greater than the RRC timeout value for the QCI level (block 520—YES and block 530—NO), then process 500 may include starting an RRC dormancy timer using the RRC timeout value associated with the QCI level (block 525). For example, base station 310 may replace the existing RRC dormancy timer with a new dormancy timer, using the RRC timeout value associated with the QCI level of the traffic, or may reset the value of the existing RRC dormancy timer to the RRC timeout value associated with the QCI level of the traffic.

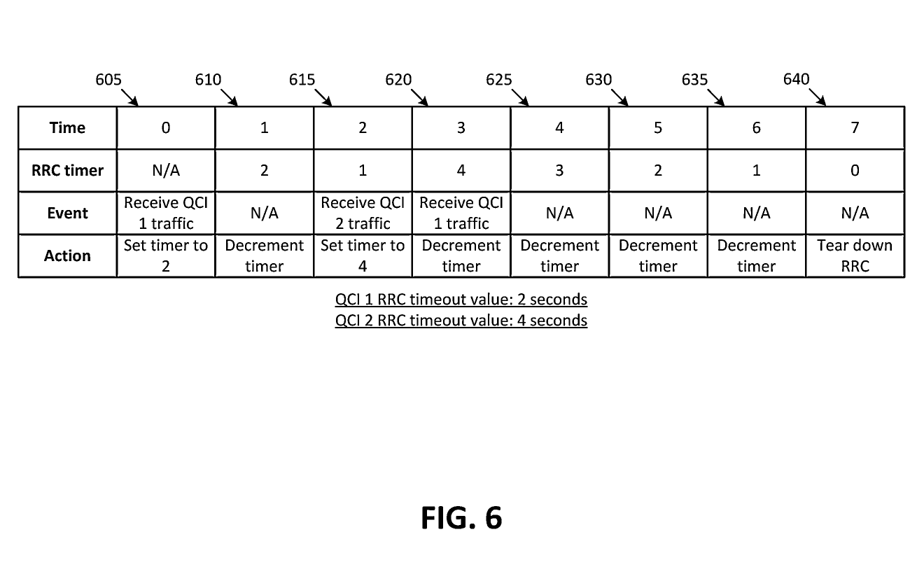

FIG. 6 conceptually illustrates an example use case of an RRC dormancy timer, in accordance with some implementations. FIG. 6 illustrates the state of an RRC dormancy timer over a sample period of seven seconds (indicated by the “time” row). In this example, up to one “event” may occur during a particular second (e.g., traffic, associated with a particular user device 305, being received). The “action” row illustrates actions that base station 310 may take each second, based on the state of the RRC dormancy timer and/or based on events that occur.

Column 605 corresponds to an RRC dormancy timer state, event, and action at time 0. At time 0, RRC dormancy timer may be “N/A,” or may not be present. Such a situation may occur when the RRC dormancy timer has previously expired, if an RRC dormancy timer was never started for the particular user device 305 in the first place, or if the RRC dormancy timer was disabled or torn down. As shown, at time 0, base station 310 may receive traffic associated with the particular user device, and may determine that the traffic is associated with QCI level 1. Base station may further determine an RRC timeout value for QCI level 1 (i.e., two seconds, in this example). Base station may thus create a new RRC dormancy timer for the particular user device 305, and may set the value of the timer to two seconds.

Column 610 corresponds to the state of the RRC dormancy timer at time 1 (e.g., one second after the information shown in column 605), as well as an event and an action at time 1. As shown, the RRC dormancy timer may have a value of 2, which was previously set, as described above. At time 1, base station 310 may not have received traffic associated with user device 305 (indicated by “N/A” in the “event” row of column 610). Base station may also decrement the RRC dormancy timer by one.

At time 3 (column 615), base station 310 may receive QCI level 2 traffic, associated with user device 310. Based on receiving this traffic, base station 310 may identify an RRC timeout value (i.e., four seconds, in this example). As described above, base station 310 may compare the identified RRC timeout value to the current value of the RRC dormancy timer. Since the RRC timeout value, for the traffic received at time 3, is greater than the current value of the RRC dormancy timer, base station 310 may set the value of the RRC dormancy timer to four seconds (i.e., the RRC timeout value associated with QCI level 2).

At time 4 (column 620), base station 310 may receive QCI level 1 traffic, associated with user device 310. Based on receiving this traffic, base station 310 may identify an RRC timeout value (i.e., two seconds, in this example). As described above, base station 310 may compare the identified RRC timeout value to the current value of the RRC dormancy timer. Since the RRC timeout value, for the traffic received at time 4, is not greater than the current value of the RRC dormancy timer, base station 310 may forgo modifying the RRC dormancy timer based on the traffic received at time 4. Instead, base station 310 may continue using the existing RRC dormancy timer, and may decrement the timer appropriately.

As shown in columns 625-640, base station 310 may continue decrementing the RRC dormancy timer when no traffic, associated with user device 305, is received. At time 7 (block 640), the RRC dormancy timer may have expired (as indicated by a value of 0 in the “RRC timer” row), and base station 310 may tear down an RRC channel associated with user device 305.

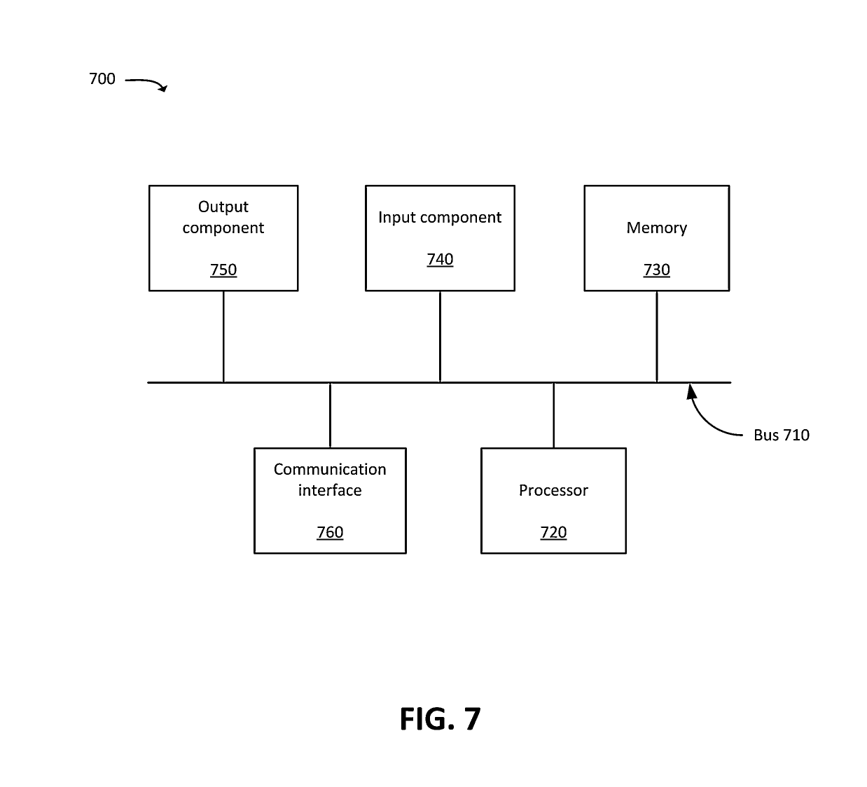

FIG. 7 is a diagram of example components of device 700. One or more of the devices described above (e.g., with respect to FIGS. 1, 2A, 2B, and 3) may include one or more devices 700. Device 700 may include bus 710, processor 720, memory 730, input component 740, output component 750, and communication interface 760. In another implementation, device 700 may include additional, fewer, different, or differently arranged components.

Bus 710 may include one or more communication paths that permit communication among the components of device 700. Processor 720 may include a processor, microprocessor, or processing logic that may interpret and execute instructions. Memory 730 may include any type of dynamic storage device that may store information and instructions for execution by processor 720, and/or any type of non-volatile storage device that may store information for use by processor 720.

Input component 740 may include a mechanism that permits an operator to input information to device 700, such as a keyboard, a keypad, a button, a switch, etc. Output component 750 may include a mechanism that outputs information to the operator, such as a display, a speaker, one or more light emitting diodes (“LEDs”), etc.

Communication interface 760 may include any transceiver-like mechanism that enables device 700 to communicate with other devices and/or systems. For example, communication interface 760 may include an Ethernet interface, an optical interface, a coaxial interface, or the like. Communication interface 760 may include a wireless communication device, such as an infrared (“IR”) receiver, a Bluetooth radio, or the like. The wireless communication device may be coupled to an external device, such as a remote control, a wireless keyboard, a mobile telephone, etc. In some embodiments, device 700 may include more than one communication interface 760. For instance, device 700 may include an optical interface and an Ethernet interface.

Device 700 may perform certain operations relating to one or more processes described above. Device 700 may perform these operations in response to processor 720 executing software instructions stored in a computer-readable medium, such as memory 730. A computer-readable medium may be defined as a non-transitory memory device. A memory device may include space within a single physical memory device or spread across multiple physical memory devices. The software instructions may be read into memory 730 from another computer-readable medium or from another device. The software instructions stored in memory 730 may cause processor 720 to perform processes described herein. Alternatively, hardwired circuitry may be used in place of or in combination with software instructions to implement processes described herein. Thus, implementations described herein are not limited to any specific combination of hardware circuitry and software.

The foregoing description of implementations provides illustration and description, but is not intended to be exhaustive or to limit the possible implementations to the precise form disclosed. Modifications and variations are possible in light of the above disclosure or may be acquired from practice of the implementations. For example, while a series of blocks has been described with regard to FIG. 5, the order of the blocks may be modified in other implementations. Further, non-dependent blocks may be performed in parallel.

Additionally, while certain implementations of timers are described above, in practice, other techniques may be employed to perform similar functions. For example, while a decrementing timer (e.g., a timer that counts down to zero from a particular value) was described above, some implementations may employ an incrementing timer (e.g., a timer that counts up to a particular value from zero). Additionally, or alternatively, while zero may be used as a starting point or an ending point for a particular timer, some implementations may use another value as a starting point or an ending point.

Further, while examples above describe determining a type of traffic based on QCI, in practice, types of traffic may be determined in other ways. For example, base station 310 (and/or another device) may, in addition to or in lieu of determining QCI of traffic, perform other types of analysis on traffic to determine its type. For example, base station 310 (and/or another device) may perform deep packet inspection and/or another technique in order to determine the content of traffic; may receive an indication of traffic type, associated with a particular user device 305, from the particular user device 305 or another device; etc.

Also, while examples above describe implementations in which an RRC channel is torn down (e.g., set to an idle mode) upon expiration of an RRC dormancy timer, an RRC dormancy timer may, in practice, be used for other purposes. For instance, upon expiration of an RRC dormancy timer, an RRC channel may be set to a different mode (e.g., may be changed from one “connected” mode to another “connected”). Further, upon expiration of an RRC dormancy timer, a new timer may be started, upon the expiration of which the RRC channel may be set to yet another mode, or torn down.

In some implementations, different RRC timeout values, which correspond to different modes, may be stored for each QCI. For instance, a first RRC timeout value may be associated with a “dedicated channel” mode, and a second RRC timeout value may be associated with a “forward access channel” mode. Assume, for instance, that a particular RRC channel is set to a “dedicated channel” mode. An RRC dormancy timer, associated with the RRC channel, may be set to the first RRC timeout value. Upon expiration of the RRC dormancy timer, the RRC channel may be set to the forward access channel mode, and the RRC dormancy timer may be set to the second RRC timeout value.

The actual software code or specialized control hardware used to implement an embodiment is not limiting of the embodiment. Thus, the operation and behavior of the embodiment has been described without reference to the specific software code, it being understood that software and control hardware may be designed based on the description herein.

Even though particular combinations of features are recited in the claims and/or disclosed in the specification, these combinations are not intended to limit the disclosure of the possible implementations. In fact, many of these features may be combined in ways not specifically recited in the claims and/or disclosed in the specification. Although each dependent claim listed below may directly depend on only one other claim, the disclosure of the possible implementations includes each dependent claim in combination with every other claim in the claim set.

Further, while certain connections or devices are shown (e.g., in FIG. 3), in practice, additional, fewer, or different, connections or devices may be used. For example, while a direct connection is shown, in FIG. 3, between OSS 315 and base station 310, in some implementations, OSS 315 and base station 310 may communicate indirectly via one or more other devices or networks. Furthermore, while various devices and networks are shown separately, in practice, the functionality of multiple devices may be performed by a single device, or the functionality of one device may be performed by multiple devices. Further, multiple ones of the illustrated networks may be included in a single network, or a particular network may include multiple networks. Further, while some devices are shown as communicating with a network, some such devices may be incorporated, in whole or in part, as a part of the network.

No element, act, or instruction used in the present application should be construed as critical or essential unless explicitly described as such. An instance of the use of the term “and,” as used herein, does not necessarily preclude the interpretation that the phrase “and/or” was intended in that instance. Similarly, an instance of the use of the term “or,” as used herein, does not necessarily preclude the interpretation that the phrase “and/or” was intended in that instance. Also, as used herein, the article “a” is intended to include one or more items, and may be used interchangeably with the phrase “one or more.” Where only one item is intended, the terms “one,” “single,” “only,” or similar language is used. Further, the phrase “based on” is intended to mean “based, at least in part, on” unless explicitly stated otherwise.

What is claimed is:

1. A method, comprising:
establishing, by a base station, a radio resource control (“RRC”) channel between the base station and a user device;
receiving, by the base station, traffic associated with the user device;
determining, by the base station, a type of the received traffic;
identifying, by the base station, an RRC timeout value associated with the type;
starting, by the base station, an RRC dormancy timer having the RRC timeout value; and
modifying, by the base station and based on expiration of the RRC dormancy timer, the RRC channel.

2. The method of claim 1, wherein modifying the RRC channel includes at least one of:
changing a mode of the RRC channel, or
tearing down the RRC channel.

3. The method of claim 1, wherein the traffic is first traffic, wherein the type is a first type, and wherein the RRC timeout value is a first RRC timeout value, the method further comprising:
receiving second traffic associated with the user device, the second traffic being received after the first traffic is received and while the RRC dormancy timer is running;
determining a type of the second traffic, wherein the type of the second traffic is a second type that is different from the first type;
identifying a second RRC timeout value associated with the second type, wherein the second RRC timeout value is different from the first RRC timeout value;
determining a present value of the RRC dormancy timer that corresponds to a time at which the second traffic was received;
determining whether the present value of the RRC dormancy timer is greater than the second RRC timeout value; and
continuing to use the RRC dormancy timer, without modifying the RRC dormancy timer based on the second RRC timeout value, when determining that the present value of the RRC dormancy timer is greater than second RRC timeout value.

4. The method of claim 1, wherein the traffic is first traffic, wherein the type is a first type, and wherein the RRC timeout value is a first RRC timeout value, the method further comprising:
receiving second traffic associated with the user device, the second traffic being received after the first traffic is received and while the RRC dormancy timer is running;
determining a type of the second traffic, wherein the type of the second traffic is a second type that is different from the first type;
identifying a second RRC timeout value associated with the second type, wherein the second RRC timeout value is different from the first RRC timeout value;
determining a present value of the RRC dormancy timer that corresponds to a time at which the second traffic was received;
determining whether the present value of the RRC dormancy timer is greater than the second RRC timeout value; and
modifying the RRC dormancy timer, based on the second RRC timeout value, when determining that the present value of the RRC dormancy timer is not greater than second RRC timeout value.

5. The method of claim 1, wherein determining the type of the traffic includes determining a quality of service class identifier (“QCI”) associated with the traffic.

6. The method of claim 1, wherein receiving the traffic associated with the user device includes at least one of:
receiving traffic sent to the user device, or
receiving traffic sent from the user device.

7. The method of claim 1, receiving information, that correlates the RRC timeout value to the type, from an operations support system (“OSS”).

8. A device, comprising:
a memory device storing a set of computer-executable instructions; and
one or more processors configured to execute the computer-executable instructions, wherein executing the computer-executable instructions causes the one or more processors to:
determine a type of traffic, received by the device from a user device;
identify a radio resource control (“RRC”) timeout value associated with the type;
start an RRC dormancy timer based on the RRC timeout value; and
modify, based on expiration of the RRC dormancy timer, an RRC channel between the device and the user device.

9. The device of claim 8, wherein executing the computer-executable instructions to modify the RRC channel further causes the one or more processors to:
change a mode of the RRC channel, or
tear down the RRC channel.

10. The device of claim 8, wherein the traffic is first traffic, wherein the type is a first type, and wherein the RRC timeout value is a first RRC timeout value, wherein executing the computer-executable instructions further causes the one or more processors to:
receive second traffic associated with the user device, the second traffic being received after the first traffic is received and while the RRC dormancy timer is running;
determine a type of the second traffic, wherein the type of the second traffic is a second type that is different from the first type;
identify a second RRC timeout value associated with the second type, wherein the second RRC timeout value is different from the first RRC timeout value;
determine a present value of the RRC dormancy timer that corresponds to a time at which the second traffic was received;
determine whether the present value of the RRC dormancy timer is greater than second RRC timeout value; and
forgo modifying the RRC dormancy timer, based on the second RRC timeout value, when determining that the present value of the RRC dormancy timer is greater than second RRC timeout value.

11. The device of claim 8, wherein the traffic is first traffic, wherein the type is a first type, and wherein the RRC timeout value is a first RRC timeout value, wherein executing the computer-executable instructions further causes the one or more processors to:
receive second traffic associated with the user device, the second traffic being received after the first traffic is received and while the RRC dormancy timer is running;
determine a type of the second traffic, wherein the type of the second traffic is a second type that is different from the first type;
identify a second RRC timeout value associated with the second type, wherein the second RRC timeout value is different from the first RRC timeout value;
determine a present value of the RRC dormancy timer that corresponds to a time at which the second traffic was received;
determine whether the present value of the RRC dormancy timer is greater than the second RRC timeout value; and
modify the RRC dormancy timer, based on the second RRC timeout value, when determining that the present value of the RRC dormancy timer is not greater than second RRC timeout value.

12. The device of claim 8, wherein executing the computer-executable instructions to determine the type of the traffic further causes the one or more processors to determine a quality of service class identifier (“QCI”) associated with the traffic.

13. The device of claim 8, wherein the received traffic corresponds to at least one of:
traffic sent to the user device, or
traffic sent from the user device.

14. The device of claim 8, receiving information, that correlates the RRC timeout value to the type, from an operations support system (“OSS”).

15. A system, comprising:
an operations support system (“OSS”) configured to:
output information correlating types of traffic to radio resource control (“RRC”) timeout values;
a base station device configured to:
receive the information, correlating types of traffic to RRC timeout values, from the OSS;
receive traffic from a user device;
determine a particular type associated with the received traffic;
identify a particular RRC timeout value associated with the particular type;
start an RRC dormancy timer based on the RRC timeout value; and
modify, based on expiration of the RRC dormancy timer, an RRC channel between the device and the user device.

16. The system of claim 15, wherein when modifying the RRC channel, the base station is configured to:
change a mode of the RRC channel, or
tear down the RRC channel.

17. The system of claim 15, wherein the traffic is first traffic, wherein the particular type is a first type, and wherein the RRC timeout value is a first RRC timeout value, wherein the base station is further configured to:
receive second traffic associated with the user device, the second traffic being received after the first traffic is received and while the RRC dormancy timer is running;
determine a type of the second traffic, wherein the type of the second traffic is a second type that is different from the first type;
identify a second RRC timeout value associated with the second type, wherein the second RRC timeout value is different from the first RRC timeout value;
determine a present value of the RRC dormancy timer that corresponds to a time at which the second traffic was received;
determine whether the present value of the RRC dormancy timer is greater than second RRC timeout value; and
forgo modifying the RRC dormancy timer, based on the second RRC timeout value, when determining that the present value of the RRC dormancy timer is greater than second RRC timeout value.

18. The system of claim 15, wherein the traffic is first traffic, wherein the particular type is a first type, and wherein the RRC timeout value is a first RRC timeout value, wherein the base station is further configured to:
receive second traffic associated with the user device, the second traffic being received after the first traffic is received and while the RRC dormancy timer is running;
determine a type of the second traffic, wherein the type of the second traffic is a second type that is different from the first type;
identify a second RRC timeout value associated with the second type, wherein the second RRC timeout value is different from the first RRC timeout value;
determine a present value of the RRC dormancy timer that corresponds to a time at which the second traffic was received;
determine whether the present value of the RRC dormancy timer is greater than the second RRC timeout value; and
modify the RRC dormancy timer, based on the second RRC timeout value, when determining that the present value of the RRC dormancy timer is not greater than second RRC timeout value.

19. The system of claim 15, wherein when determining the particular type of the traffic, the base station is configured to determine a quality of service class identifier (“QCI”) associated with the traffic.

20. The system of claim 15, wherein the received traffic corresponds to at least one of:
traffic sent to the user device, or
traffic sent from the user device.
